(19) United States
(12) Patent Application Publication
(10) Pub. No.: US 2001/0003289 A1
(43) Pub. Date: Jun. 14, 2001

(54) MODULAR ELECTRONIC VALVE OPERATED FLUID CONTROL SYSTEM

(75) Inventors: MARCUS MEAD, CORNWALL (GB); GARY ALAN SHAW, CORNWALL (GB); ALAN PAUL ROSS, CORNWALL (GB)

Correspondence Address: JOHN P DELUCA, DYKEMA GOSSET PLLC, 1300 I STRTEET N.W., 3RD FLOOR, WASHINGTON, DC, 20005, US

(73) Assignee: John P. DeLuca

(21) Appl. No.: 09/447,342

(22) Filed: Nov. 22, 1999

(51) Int. Cl. F16K 11/00

(52) U.S. Cl. 137/884; 137/269

(57) ABSTRACT

A modular fluid control system is disclosed in which a common fluid manifold is formed by the connection of a required number of identical manifold modules (4). Each manifold module (4) has a valve module (9) connected thereto with connections to receive and return fluid from/to the manifold. In addition, each manifold module (4) includes data/power connectors (36, 37) which allow connection to adjacent manifold modules (4) thereby forming a common power and data bus through the connected manifold modules (4). Each manifold module (4) includes a controller (18) capable of controlling the valve within its connected valve module (9) in accordance with instructions received from a primary controller (16) connected to the data/power bus at one end of the common manifold. The primary controller (16) is connected to an external PLC which controls operation of the valves by outputting in parallel, control signals (one per valve) which are converted to a serial control signal by the primary controller (16) for transmission on the common data bus. The system is particularly suitable to simple construction and alteration.

This invention relates to solenoid actuated fluid (such as hydraulic or pneumatic) control systems and in particular, though not solely, to control systems for modular manifold mounted valve systems.

In many industrial applications, it is necessary to provide a large number of individually controllable pneumatic or hydraulic fluid lines. In practice, this requires at least one electronically operated solenoid valve to be provided for each fluid line. Rather than provide each valve with its own power and control leads, which would be impractical, it is known to connect all of the solenoid valves with a single power supply, to provide a common data bus on which control signals are transmitted and to provide each valve with a control unit which is capable of interpreting the control signals and operating its valve at the appropriate time. One example of such a system is disclosed in European Patent application publication number EP-A-299655.

Valve control systems as described above are generally complex, requiring elaborate control protocols and data decoders within the valve controllers, to derive the instructions specific to their individual valve. In addition or alternatively, it is usually necessary to provide each valve with its own unique pre-set address or means to set a unique address (such as a position encoder) to enable messages to be transmitted to particular valves. This introduces further complexity and also provides an opportunity for problems to be introduced into the system if the addresses are not unique. Furthermore, although some of the valve control systems designed using the abovementioned principles may be described as “modular”, for example the system disclosed in U.S. Pat. No. 5,522,431 in which a common fluid manifold is produced by combining a number of separate manifold modules, they are not necessarily compatible with simple system construction or system expansion as they are usually pre-configured by the manufacturer (who sells systems through a distributor) according to a customer's specific requirements for a particular installation at a particular time and do not allow for alteration by adding or removing valves without the need for substantial readjustment or system rewiring/ reprogramming.

It would be advantageous to provide a modular electronic valve operated fluid control system in which the distributor could build and adjust the system by simply fitting together the required components in the desired configuration from a small number of different standard stocked component types which, when powered up, was fully configured and ready for operation without the need for additional complicated wiring

It is therefore an object of the present invention to provide a valve control system which will go at least some way towards overcoming the above mentioned disadvantages.

Accordingly, the invention consists in a fluid control system having a primary control means including means to receive in parallel electronic control signals and a connection to a source of electrical power,

a plurality of manifold modules which when connected in series define a common manifold adapted to receive a supply of compressed fluid, each manifold module including electrical connection means which connect with electrical connection means of adjacent manifold modules to form an electrical bus to allow passage of power and control signals to each manifold module in series through a connection with said primary control means,

wherein each of said manifold modules are provided with a valve module which includes at least one valve, each valve module receiving power to operate said at least one valve and fluid, the passage of which is controlled by said at least one valve, through a connection with its manifold module, and

wherein each manifold module includes a secondary control means which controls operation of said at least one valve in accordance with the control signals received via an electrical connection with its manifold module,

characterised in that said primary control means also includes means for converting said received parallel electronic control signals into serial electronic control signals which constitute the instructions received by the secondary control means of said manifold modules.

Particular embodiments of the invention will now be described with reference to the accompanying drawings in which:

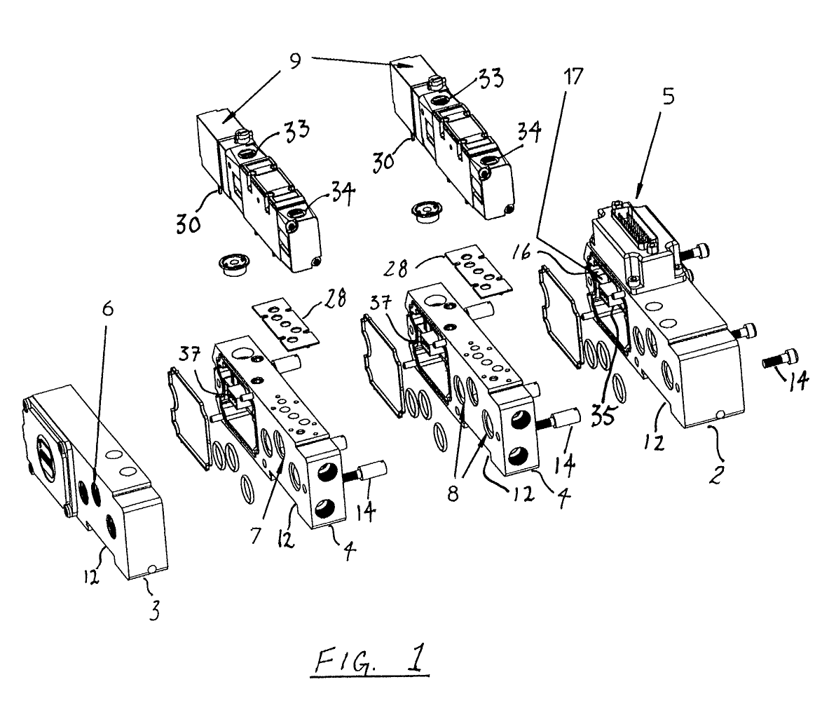

FIG. 1 is an exploded perspective view of an example modular electronic valve operated fluid control system in accordance with the present invention which includes two manifold modules and two valve modules,

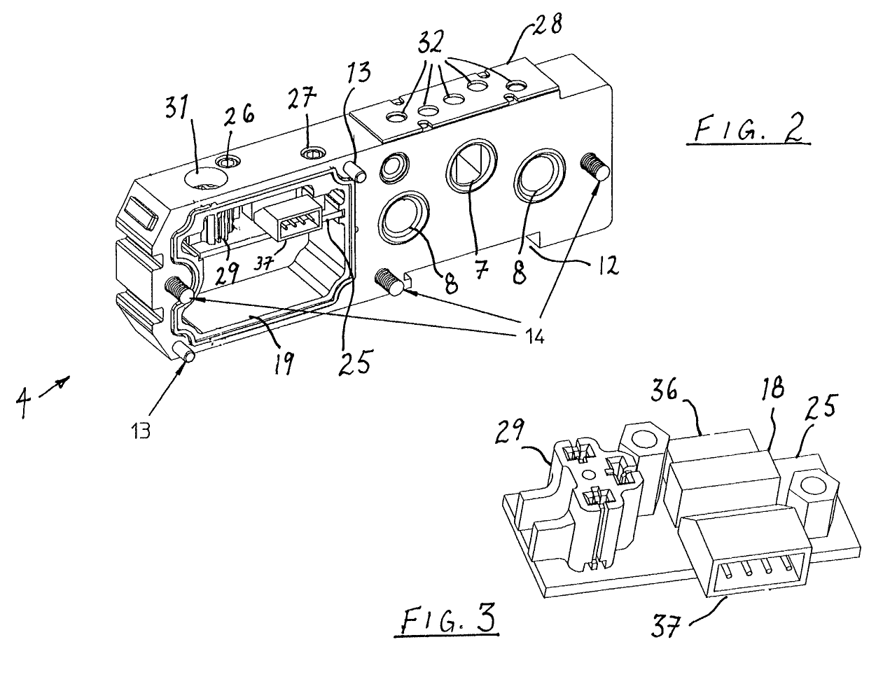

FIG. 2 is a perspective view of a manifold module as shown in FIG. 1,

FIG. 3 is a perspective view of the printed circuit board of the manifold module of FIG. 2,

FIG. 4 is a perspective view of an ancillary input module which may optionally be used with the system of FIG. 1,

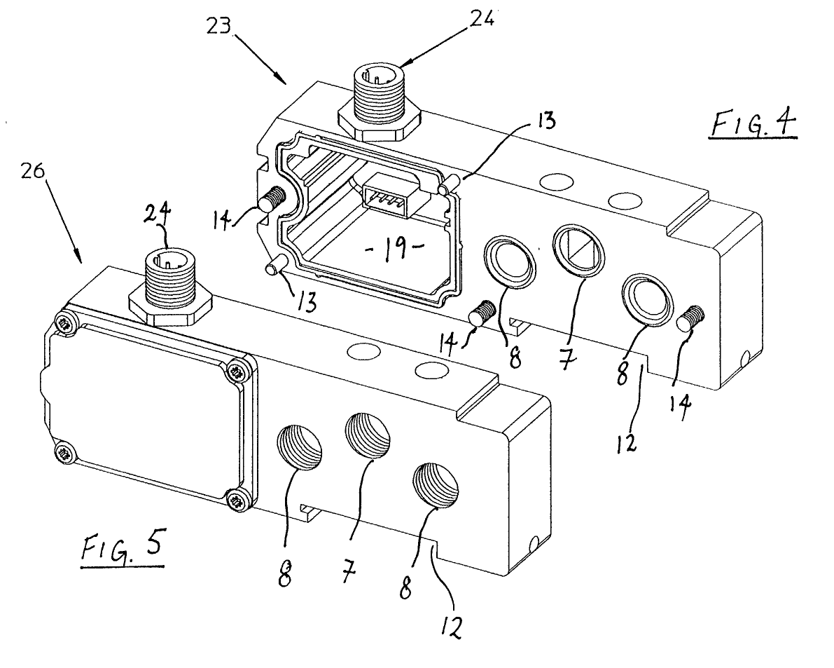

FIG. 5 is a perspective view of an ancillary output module which may optionally be used with the system of FIG. 1,

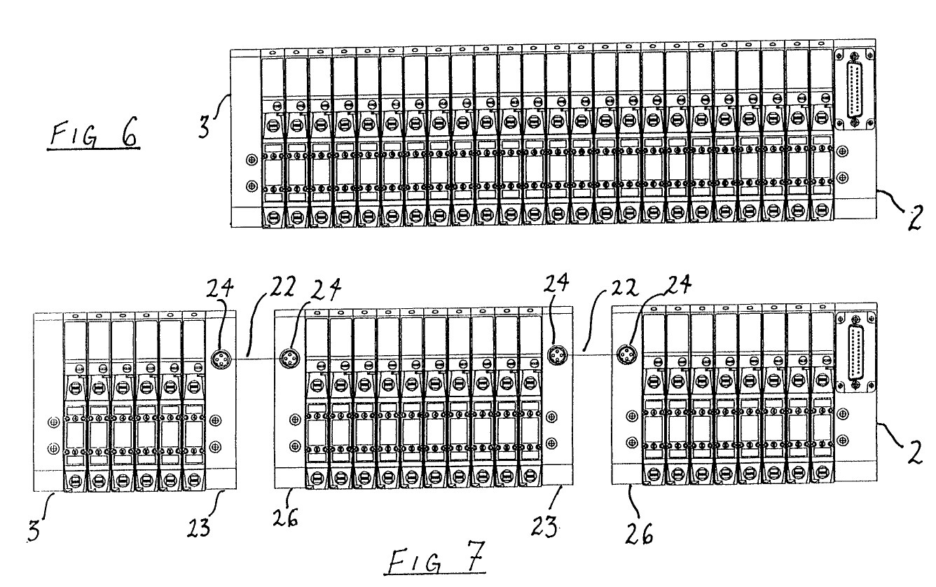

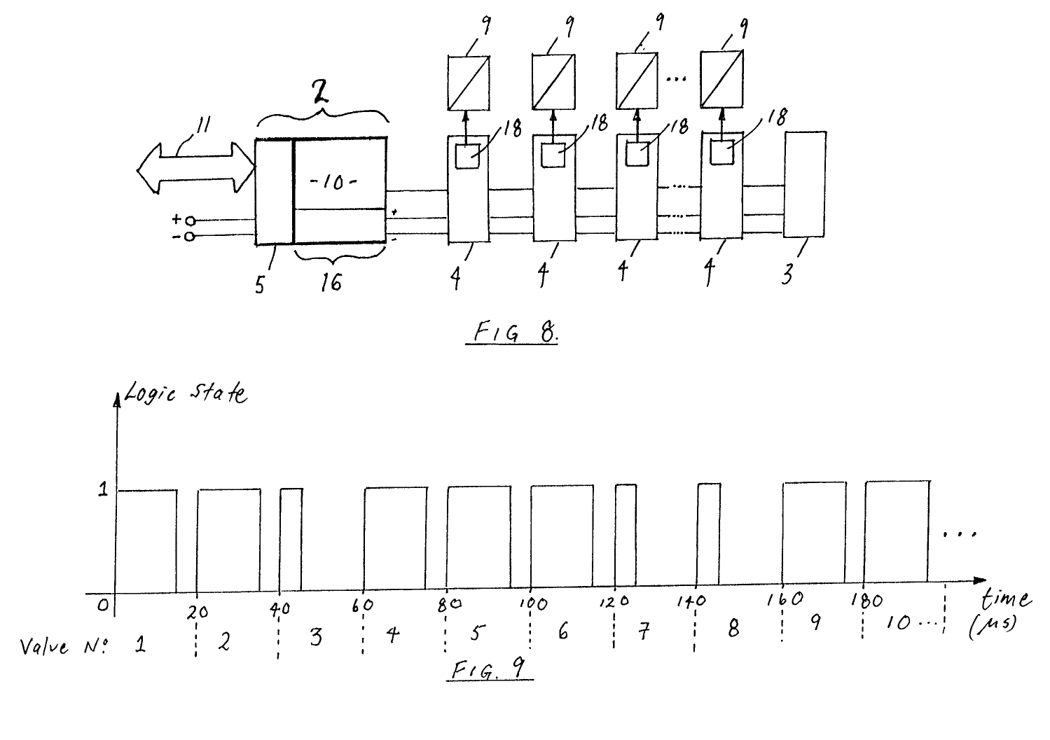

FIG. 6 is a front view of a single manifold system in accordance with the present invention which includes 24 manifold modules and 24 valve modules,

FIG. 7 is a front view of a series of separate, “daisy chained” groups of manifold systems in accordance with the present invention which includes 24 manifold modules and 24 valve modules,

FIG. 8 is a schematic diagram showing the electrical connections in a valve operated fluid control system according to the present invention, and

FIG. 9 is a timing diagram showing the serial control signal output by the primary control processor shown in FIG. 1.

With reference to the drawings, and in particular FIG. 2, a manifold module 4 is shown. Manifold module 4 is preferably extruded or die cast from an aluminium alloy or alternatively formed from an injection moulded plastics material. It can be seen that a passage 19 passes completely through the manifold module 4 from one side to the other. Means are provided within the passage 19 to mount a single printed circuit board 25 (see FIG. 3) which is preferably secured within the passage by two bolts, tapped screws or dowel pins 26 and 27.

The manifold module 4 also includes a fluid conduit 7 which passes completely through the module from one side to the other but is also in fluid communication with selected ones of the valve orifices 32 on a top surface of the manifold module. A valve interface plate 28, which is preferably a rubber gasket, is positioned over the valve orifices and has a series of holes aligned with the orifices. Exhaust conduits 8 are also provided in the manifold module 4 in order to return exhausted fluid returned from selected ones of the valve interface orifices of the valve interface plate.

With reference now to FIG. 1, it can be seen that a modular electronic valve operated fluid control system may be built up from a desired number of manifold modules 4 (two in the example shown). The modular electronic valve operated fluid control system may be for example a pneumatic or a hydraulic system wherein pressurised fluid (such as air or oil) is supplied and channeled through the modules and valves are used to control the flow of the pressurised fluid.

It can be seen in FIG. 1 that each manifold module is connected to an adjacent manifold module so that the passage 19, the fluid conduit 7 and the exhaust conduits 8 are aligned thereby forming a common manifold. At one end of the connected series of manifold modules is connected a primary control module 2 and at the other end of the connected series of manifold modules is provided an endplate module 3. Either of the primary control module 2 or the endplate module 3 may be connected so as to receive an external supply of pressurised fluid (for example via supply port 6 of endplate module 3) which is channeled through the common manifold and may also receive the combined exhaust fluid from the exhaust conduits 8. The base of each of the primary control module 2, the manifold modules 4 and the endplate module 3 are all provided with a recessed channel 12 which is provided for connection to a mounting means so that the modules can be conveniently positioned in an appropriate place.

One valve module 9 is provided for each manifold module 4. The valve module 9 contains at least one electronically operated valve, for example a solenoid valve, which is powered through a plug 30 and socket 29 type connection with its manifold module. The solenoid valves may, for example, be of a mono-stable type (changing from an unenergised state to an energised state upon receipt of an appropriate control signal but requiring power to maintain in its energised state) or a bi-stable type (changing from one state to another upon receipt of appropriate control signals and not requiring power to remain in either state). Access to the socket 29 (which is mounted on the printed circuit board 25) is provided via a hole 31 in the top surface of the manifold module. The valve modules 9 also include input and output pressurised fluid orifices (not shown) which are aligned with the respective valve orifices 32 of the manifold module 4 with the valve interface plate 28 sandwiched in between. Fluid outlet ports 33 and 34 are provided on each valve module 9 for connecting fluid couplings to transport the flow controlled pressurised fluid to appropriate industrial machinery or processes.

The primary control module 2 has a similar design to the manifold modules 4 and also includes a printed circuit board 17. Printed circuit board 17 includes a primary control means or primary control processor 16 which receives power and electronic control signals in parallel from, and may optionally transmit parallel data to, an external programmable control device (not shown) via a data connector 5 which may, for example, be a 25 way Sub-D interface or DB-25 connector. Printed circuit board 17 also includes parallel to serial data conversion means 10 (see FIG. 8), including for example shift registers or a suitably programmed microprocessor, for converting the incoming parallel electronic control signals to serial electronic control signals (and optionally vice versa) which are applied to conductors within a female electronic connector 35.

Electronic connector 35 includes for example four pins, two of which provide a source of electric power and the remaining two of which may be used as data lines for transmitting the aforementioned serial electronic control signals in either direction. Alternatively, if only one way data communication from the primary control module 2 to the manifold modules 4 is required then a three wire system could be employed. Preferably the serial electronic control signals are produced in the form of a type of pulse width modulated signal and will be described in more detail below.

The printed circuit board 25 within each manifold module includes the aforementioned socket 29 providing power to a valve module and in addition includes male 36 and a female 37 electronic connectors. The female electronic connector 37 is adapted to connect to the male electronic connector of an adjacently positioned manifold module or to a male electronic connector of an endplate module 3 thereby forming a common bus for data communications through each manifold module. The male electronic connector 36 is adapted to either connect to the female electronic connector 35 of the primary control module 2 or to the female electronic connector of an adjacent manifold module.

In order to assist in alignment of the manifold modules and in particular the electronic connectors during assembly of the valve control system, alignment pins 13 are provided on one side of the module components which fit within holes positioned in the corresponding positions on the adjacent face of another of the modules. In order to hold the modules together, threaded studs 14 are provided which fix each module to its adjacent left hand side module and provide a threaded hole for the threaded stud of the adjacent right hand side module to be secured to.

The printed circuit board 25 also includes a secondary control means or secondary processor 18 which may be a suitably programmed microprocessor or may be a hard wired circuit which receives control signals from the serial electronic control signals transmitted over the common bus. The detailed operation of the secondary control means 18 will be described below but it should be noted at this stage that the control signals received by any particular secondary control means 18 cause it to regulate the supply of power (in accordance with the issued instructions of-an external programmable electronic device) to socket 29 and therefore to control the switching operation of the at least one valve within the valve module attached thereto.

With reference to FIGS. 6 and 7, two example configurations of assembled valve operated fluid control systems are shown. In FIG. 6, 24 manifold modules and 24 valve modules are connected to form a common manifold and a common electrical power and data bus between an endplate module 3 and a primary control module 2. In FIG. 7, three “daisy chained” groups of manifold modules are shown which may be separated physically depending on the locations at which they are needed within a factory or industrial plant. The example of FIG. 7 still includes a single primary control module 2 and an endplate module 3 at the two extreme ends of the system, however ancillary output modules 26 (see FIG. 5) and ancillary input modules 23 (see FIG. 4) are provided at the ends of the intermediate groups of modules. The ancillary input and output modules are provided with 4-way connection interfaces 24 to allow connection of cable connecting the power and data lines of the adjacent groups of manifold modules. One of the ancillary input or output modules may be provided with a separate connection to a supply of pressurised fluid or, alternatively, may receive pressurised fluid via a connection with an adjacent group of manifold modules.

In order to install a pressurised fluid valve control system according to the present invention it is simply necessary to obtain and connect the required number of manifold modules and valve modules along with an endplate module and a primary control module 2 (it should be noted that due to the simplicity of the present system, this task may be undertaken by the component distributor rather than the manufacturer). The modules need be connected together as detailed above and provided with a supply of power and control signals via data connector 5 of the primary control module 2. It should be noted that due to the way in which the threaded studs 14 are positioned, system construction takes place from left to right (as shown in FIGS. 1 to 6 and 7) so that the final component to be connected is the primary control module 2. Once the system is powered up it is ready for use without the need to individually set unique addresses for each manifold module. Furthermore, if additional manifold modules are added, upon start up of the system they will be ready for use without any further rewiring or detailed programming adjustments necessary. This is due to the way in which data is communicated between the primary control module 2 and the series of secondary control means 18 and is detailed below.

In use, and with reference in particular to FIG. 8, a suitable Programmable Logic Controller (PLC, not shown) is connected via a parallel type, preferably 24 conductor, cable 11 to data connector 5 of primary control module 2. The PLC is programmed to control operation of each of the valves of the multiple valve modules 9 (only 4 of the possible 24 valves are illustrated in FIG. 8) by outputting in parallel control signals (one per valve module) in a predetermined format (described further below) which are received by the 24 pins of data connector 5 (ordinarily, each pin is assigned to one specific secondary control means 18). Upon receipt of the parallel electronic control signals destined for particular of the valves, the parallel to serial conversion means 10 converts the parallel signals into serial electronic control signals in a time division multiplexed fashion and places them on the common data bus. As the serial data signal passes the secondary control means in turn, the part of the serial signal intended for that particular secondary control means 18 is received and removed (or blocked) from the serial signal by the particular secondary control means 18 before being passed through to the next adjacent secondary control means. As previously mentioned, a second (or return) data line may be provided to allow data (for example error codes or state information) to be transmitted from the valves back to the primary control processor 16 and/or PLC. Alternatively, return data could be transmitted over the same conductor as the control signals using different time or frequency channels.

A primary control module 2 can control up to a maximum of, for example, 24 manifold/valve modules. Accordingly, the serial control signals will include 24 consecutive blocks of separate instructions, one for each secondary control means 18. The first secondary control means in the system will remove and act upon the first block of data sent by the primary control processor 16, the second secondary control means will act upon the second block of data sent by the primary control processor 16 and so on up until the serial data signal contains only the twenty fourth block of information intended for the twenty fourth secondary control means. Data from a particular secondary control means is formatted so as to identify the secondary control means from which it originates (for example by being positioned in an appropriate “time slot” reserved for that secondary control means) and may then be transmitted back to the primary control module 2 by being relayed through each of the secondary control means 18.

The format of the control signals issued by the PLC and subsequently combined into a serial control signal is illustrated in the example of FIG. 9. It should be noted that the primary control processor 16 could be provided with additional processing capability to allow it to produce the pulse width modulated valve control signal upon receipt of differently formatted (for example digital) information from the PLC.

In FIG. 9, it can be seen that a “time slot” or block is provided for each valve (or secondary control means) and is, for example, 20 μs in duration. In the example shown, the signal is a PWM signal in which the pulse within each block has a duration of 15 μs if the valve to which that block is assigned should be turned ON, or 5 μs if the valve assigned to that block should be turned OFF. In FIG. 9, valves 3, 7 and 8 will be turned OFF.

The secondary control means within the manifold modules, upon system startup, are synchronised with the primary control processor 16 and “listen” for the instructions within their allotted time slot. In practice, this is preferably accomplished by arranging each secondary control means to act upon the first pulse (having a duration of at least 5 μs for example) it receives in the control signal and then removing (or blocking) that pulse from the data stream passed through to the next module.

Preferably, at the end of the 24 “blocks” of instructions, a short pulse of for example 1 or 2 μs is transmitted which signals the secondary control means that the control signals have ended and that they may now transmit input data to the primary control processor 16. At the end of a predetermined period set aside for this input (for example 100 μs), a further short pulse is transmitted signaling to the secondary control means that they should stop transmitting and prepare to receive their next instructions comprising an updated pulse train from the primary control processor 16.

As noise in the control signal could cause a logic level of “1” to be interpreted as a “0” (or vice versa), each secondary control means will only change its state if it receives a predetermined consecutive number (for example, three) of the same type of control pulses. Accordingly, if for example a valve was initially in an OFF state and its secondary control means was to receive two consecutive 15 μs pulses and then either a 5 μs pulse or a logic level of “0” in its assigned time slot, then it would not switch the valve to an ON state and would ignore the previous two 15 μs pulses and begin counting pulses again from zero.

As already mentioned, it is possible to either install mono-stable or bi-stable valves within any of the valve modules 9. As these valves operate in considerably different fashions, they also require differently formatted control signals. For example, it may be necessary to reserve two pins in data connector 5 for each bi-stable valve, the first of the two pins used to switch the valve to an ON state and the other of the two pins used to switch the valve to an OFF state. In this example, each secondary control means attached to a bi-stable type valve will “listen” to two contiguous 20 μs time slots (this may, for example, be accomplished by connecting two mono-stable type secondary control means “back-to-back”). Accordingly, the PLC controlling operation of the valves will require knowledge of the type or functionality and position of each valve in the system in order to tailor the control signals appropriately. Obviously this information will need to be updated upon changes in the configuration of the system taking place.

Accordingly, in its preferred form the present invention provides an automatic “virtual connection” between valves at any given location in the manifold with their correct pin number in the connector 5. In the event that the configuration of the system requires changing then the manifold may be quickly disassembled, valves and associated manifold modules added or removed and then reassembled. The new positions of the valves will then correspond to the correct pin number on connector 5 once more without the need to rewire the system.

1. A fluid control system having a primary control means (16) including means to receive in parallel electronic control signals and a connection to a source of electrical power,
a plurality of manifold modules (4) which when connected in series define a common manifold adapted to receive a supply of compressed fluid, each manifold module (4) including electrical connection means (36, 37) which connect with electrical connection means (36, 37) of adjacent manifold modules (4) to form an electrical bus to allow passage of power and control signals to each manifold module (4) in series through a connection (35) with said primary control means (16),
wherein each of said manifold modules (4) are provided with a valve module (9) which includes at least one valve, each valve module (9) receiving power to operate said at least one valve and fluid, the passage of which is controlled by said at least one valve, through a connection (32) with its manifold module (4), and
wherein each manifold module (4) includes a secondary control means (18) which controls operation of said at least one valve in accordance with the control signals received via an electrical connection (29, 30) with its manifold module (4),
characterised in that said primary control means (16) also includes means (10) for converting said received parallel electronic control signals into serial electronic control signals which constitute the instructions received by the secondary control means (18) of said manifold modules (4).

2. A fluid control system as claimed in claim 1, wherein each manifold module (4) is identical and it is unnecessary to provide each manifold module (4) with a unique address in order to ensure that instructions are routed correctly to an intended manifold module (4).

3. A fluid control system as claimed in claim 1 or claim 2, wherein said serial electronic control signals comprise a number of consecutive blocks of instructions wherein one block of instructions is provided for each manifold module (4).

4. A fluid control system as claimed in claim 3, wherein the order of the consecutive blocks of instructions in said serial electronic control signals corresponds to the order of connection of the manifold modules (4) in said common manifold.

5. A fluid control system as claimed in claim 3 or claim 4, wherein as a particular block of instructions is received by the secondary control means (18) of a particular intended manifold module (4), that particular block of instructions is removed or blocked from the serial electronic control signals prior to being passed on to the secondary control means (18) of the next adjacent manifold module (4).

6. A fluid control system as claimed in any one of the preceding claims, wherein said primary control means (16) is housed within a primary control module (2) connected to the series of connected manifold modules (4) at one end thereof and an endplate module (3) is attached to the other end of the series of connected manifold modules (4), wherein either of the endplate module (3) or the primary control module (2) is provided with means for connection to said supply of compressed fluid.

7. A fluid control system as claimed in any one of the preceding claims, in which said electrical bus comprises four individual conductors and wherein said secondary control means (18) are capable of transmitting data signals back to said primary control means (16) via said bus.

8. A fluid control system as claimed in any one of the preceding claims, wherein each said manifold module (4) is formed in a single piece as an extrusion and includes a passage (19) there through adapted to be aligned with the passages (19) of adjacent manifold modules (4), the passage (19) providing means for receiving a single printed circuit board (25) on which is mounted said secondary control means (18), said electrical connection means (36, 37) and means (29) providing an electrical connection with a valve module.
